(19) United States
(12) Patent Application Publication
(10) Pub. No.: US 2007/0003342 A1
(43) Pub. Date: Jan. 4, 2007

(54) Automatic document feeder with a single drive roller

(76) Inventors: Ramanathan Alaganchetty, Singapore (SG); Richard Neo Hee Hock, Singapore (SG)

Correspondence Address: HAVERSTOCK & OWENS LLP, 162 NORTH WOLFE ROAD, SUNNYVALE, CA, 94086, US

(21) Appl. No.: 11/417,834

(22) Filed: May 3, 2006

Related U.S. Application Data
(60) Provisional application No. 60/677,685, filed on May 3, 2005.

(51) Int. Cl. G03G 15/00

(52) U.S. Cl. 399/367

(57) ABSTRACT

An automatic document feeder with a single drive roller including a drive roller wheel is provided. The single drive roller is the only drive roller in the automatic document feeder. The single drive roller also includes a drive roller shaft extending through the center of the drive roller wheel. The drive roller shaft is fixed to the center of the drive roller wheel and applies a torque to the drive roller wheel.

### CROSS REFERENCE TO RELATED APPLICATIONS

This application claims priority of U.S. provisional patent application Ser. No. 60/677,685, filed on May 3, 2005 and entitled AUTOMATIC DOCUMENT FEEDER WITH A SINGLE DRIVE ROLLER. The U.S. provisional patent application Ser. No. 60/677,685 is also incorporated by reference in its entirety.

### BACKGROUND OF THE INVENTION

1. Field of the Invention

The present invention relates to automatic document feeders. More particularly, the present invention relates to an automatic document feeder for automatically passing a document over a scan window of an analog or digital device for copying, printing, faxing or image reading.

2. Discussion of Background

FIG. 1 (Prior Art) is a side view diagram of a conventional automatic document feeder 100. Most automatic document feeders have at least 2 to 4 drive rollers, excluding any pick rollers. Automatic document feeder 100 includes 4 drive rollers and a pick roller. This set of drive rollers includes a feed roller 104, a pre-scan roller 106, a post scan roller 108 and an eject roller 110. Automatic document feeder 100 also includes a pick roller 102. Pinch rollers 1 2 hold paper flush against the drive rollers as the paper passes through the automatic document feeder.

Unfortunately, an automatic document feeder having multiple drive rollers is inherently complicated. Each drive roller is powered by its own gear train. An automatic document feeder having 4 drive rollers, as in FIG. 1, has 4 gear trains, one for each drive roller. Multiple drive rollers present a “take over” problem. In other words, when a drive roller disengages a sheet of paper and the next drive roller takes over the sheet of paper, differences between the drive rollers may cause a paper error. Multiple drive rollers are bound to have timing inconsistencies because the rollers may have different parts, different manufacturing processes, inconsistent calibrations and may wear differently from one another. For example, each drive roller may have a different diameter, or the gear trains may operate at different phases or speeds. Even an insubstantial diameter, phase or speed difference could cause a paper error. The drive trains have to be operating perfectly in synchronization for the paper to contact accurately the drive rollers and travel through the automatic document feeder without any errors. Any lapse in coordination between the drive rollers could cause paper to bunch up, jam or tear.

What is needed is an automatic document feeder having a less complex drive train system such that fewer paper errors can be achieved.

### SUMMARY OF THE INVENTION

The present invention fills this need by providing an automatic document feeder with a single drive roller. It should be appreciated that the present invention can be implemented in numerous ways, including as an apparatus, a system or a device. Inventive embodiments of the present invention are summarized below.

In one embodiment, an automatic document feeder comprises a single drive roller including a drive roller wheel. The single drive roller is the only drive roller in the automatic document feeder. The single drive roller also includes a drive roller shaft extending through the center of the drive roller wheel. The drive roller shaft is fixed to the center of the drive roller wheel and applies a torque to the drive roller wheel.

In another embodiment, a single drive roller for use in an automatic document feeder is provided. The single drive roller comprises a drive roller wheel. The single drive roller is the only drive roller in the automatic document feeder. The single drive roller also comprises a drive roller shaft extending through the center of the drive roller wheel. The drive roller shaft is fixed to the center of the drive roller wheel. The drive roller wheel includes a circumferential surface having traction to grip a media sheet onto the circumferential surface.

Advantageously, the automatic document feeder of the present invention is simpler than a conventional automatic document feeder. Having a single drive roller substantially eliminates feed errors. The automatic document feeder undergoes no difference in linefeed because no other drive rollers are in the automatic document feeder. Further, the single drive roller ensures that the media sheet travels through the automatic document feeder at a substantially constant linear speed. The single drive roller also provides an economic advantage because an automatic document feeder with a single drive roller is substantially less costly than an automatic document feeder with multiple drive rollers.

The invention encompasses other embodiments, which are configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 (Prior Art) is a side view diagram of a conventional automatic document feeder;

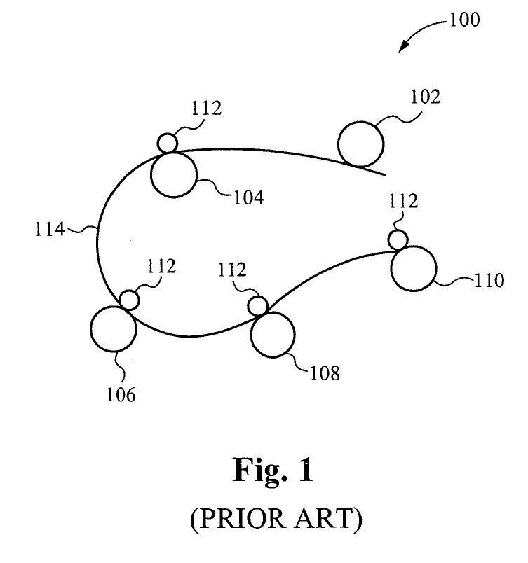

FIG. 2 is a functional diagram showing internal components of an automatic document feeder with a single drive roller, in accordance with the present invention.

FIG. 3 is a perspective view of the automatic document feeder of FIG. 2, in accordance with the present invention.

FIG. 4 shows an automatic document feeder having a pick arm, in accordance with the present invention.

FIG. 5 is a side view showing mechanics of the float bias of an automatic document feeder, in accordance with the present invention.

FIG. 6 is a side view of the transmission gear train of the automatic document feeder, in accordance with the present invention.

FIG. 7 is a perspective view of the transmission gear train of the automatic document feeder, in accordance with the present invention.

FIG. 8 is a side view of the automatic document feeder of FIG. 4, in accordance with the present invention.

### DESCRIPTION OF THE PREFERRED EMBODIMENTS

An invention for an automatic document feeder with a single drive roller is disclosed. Numerous specific details are set forth in order to provide a thorough understanding of the present invention. It will be understood, however, to one skilled in the art, that the present invention can be practiced with other specific details.

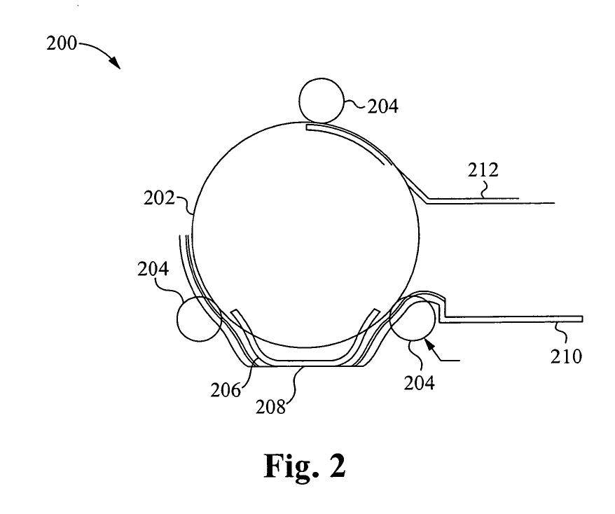

FIG. 2 is a functional drawing showing internal components of an automatic document feeder 200 with a single drive roller, in accordance with the present invention. The single drive roller includes a drive roller wheel 202. The drive roller wheel 202 is the primary force for moving media sheets from the input tray 212 through the automatic document feeder 200 to the output tray 210. A media sheet can be a sheet of paper, a transparency, an envelope or other type of media. Pinch rollers 204 provide a pinch force against the single drive roller 202. The pinch force assists in holding the media sheet against the driver roller wheel 202 as the media sheet passes through the automatic document feeder 200. The pinch force allows the pinch rollers 204 to follow the motion of the drive roller wheel 202. In other words, the drive roller wheel 202 powers the pinch rollers 204 via the pinch force between the pinch rollers 204 and the drive roller wheel 202.

A float bias 206 assists in pressing the media sheet against the scan window (not shown) at the scan point 208. By pressing down with the appropriate amount of pressure on the media sheet, the float bias 206 allows the scan window to have a higher quality pixel scan. The float bias 206 and scan window are positioned substantially directly below the drive roller wheel 202. The diameter of the drive roller wheel 202 is such that a media sheet can smoothly glide between the float bias 206 and the scan window to obtain an accurate scan. In this example, the diameter of the drive roller wheel 202 is preferably between about 50 mm and about 53 mm, and more preferably about 51.744 mm. However, the diameter can have other dimensions depending on the design of the float bias 206 and other components of the automatic document feeder 200.

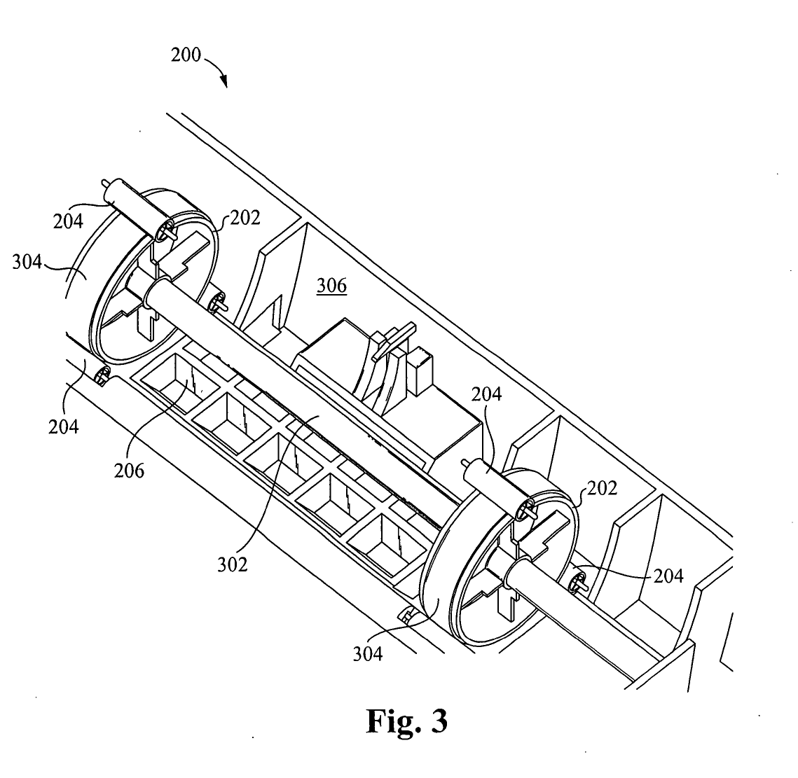

FIG. 3 is a perspective view of the automatic document feeder 200 of FIG. 2, in accordance with the present invention. This perspective view reveals additional features of the single drive roller. The single drive roller includes at least one drive roller wheel 202 and a drive roller shaft 302. The single drive roller of FIG. 3 includes two drive roller wheels 202. The invention can be implemented with only one drive wheel 202 or many drive wheels 202, depending upon the specific goals of the application. The drive roller shaft 302 extends through the center of each drive roller wheel 202 and is fixed to the drive roller wheels 202. The drive roller shaft is preferably metal. The drive roller wheel 202 has a circumferential surface 304, which is made of a material having traction to grip a media sheet as the media sheet passes between the drive roller wheels 202 and the pinch rollers 204. Such material can be rubberized or consist of some other type textured surface that provides traction. The example of FIG. 3 shows 3 pinch rollers 204 contacting each drive roller wheel 202 at different locations of each drive roller wheel 202. A chassis 306 holds components of the automatic document feeder 200. The chassis 306 can also operate as a paper guide for media sheets sitting on the input tray 212, passing through the automatic document feeder 200, or discharging onto the output tray 210.

Having a single drive roller substantially eliminates feed errors. The traction of the circumferential surfaces 304 provides traction from the single drive roller. Accordingly, the automatic document feeder 200 undergoes no difference in linefeed because no other drive rollers are in the automatic document feeder 200. Further, the single drive roller ensures that the media sheet travels through the automatic document feeder 200 at a substantially constant linear speed.

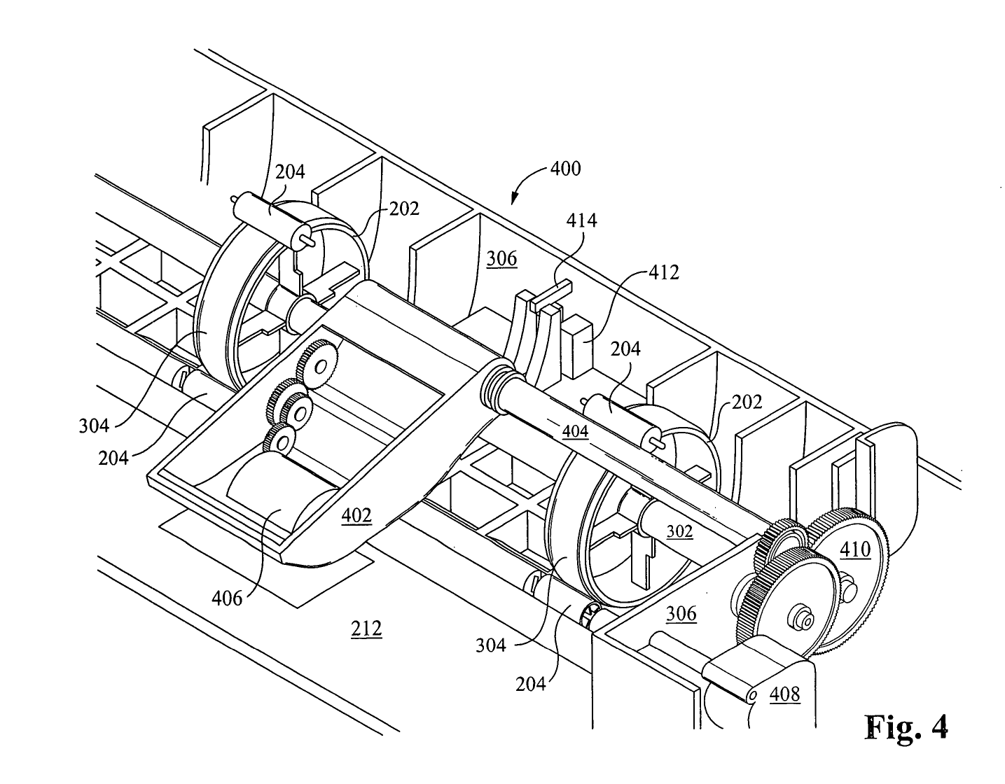

FIG. 4 is a perspective view showing an automatic document feeder 400 having a pick arm 402, in accordance with the present invention. The pick arm 402 with a mounted pick roller 406 picks and separates a media sheet from a stack of media sheets sitting on the input tray 212. The stack of media sheets can be, for example, between 1 and 100 sheets of paper. Even more sheets are possible. The pick arm is coupled to a pick arm shaft 404. The pick arm shaft 404 is coupled to a transmission gear train 410. The transmission gear train 410 is coupled to a motor 408. The power generated by the motor 408 powers the pick arm 402 via the transmission gear train 410 and pick arm shaft 404, among other things. A pick roller 406 is mounted on the pick arm 402. The motor 408 can also provide power to the drive roller shaft 302. The drive roller shaft 302 can then provide a torque to the drive roller wheel 202.

An out of paper sensor (OOPS) 412 senses when the automatic document feeder 400 is out of media sheets. An out of paper lever provides notification when the OOPS 412 senses that the automatic document feeder 400 is out of media sheets.

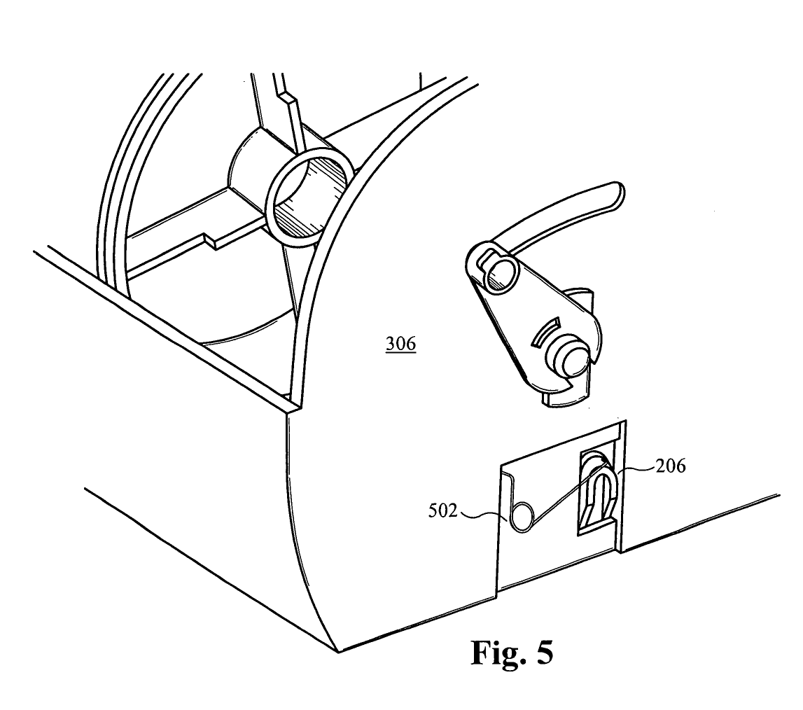

FIG. 5 is a side view showing mechanics of the float bias of the automatic document feeder 400, in accordance with the present invention. A spring 502 biases the float bias 206 vertically downward. The float bias presses a media sheet downward onto the scan window (not shown) as the media sheet passes over the scan window. The scan window scans a media sheet for the purpose of copying, faxing, printing or image reading the media sheet in analog or digital format.

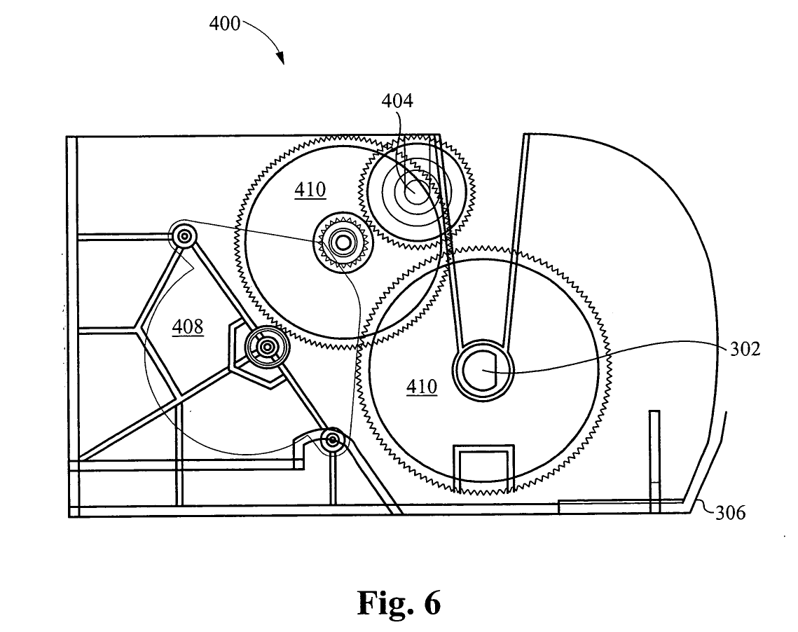

FIG. 6 is a side view of a representative transmission gear train 410 of the automatic document feeder 400, in accordance with the present invention. The transmission gear train 410 is coupled to the motor 408 and supplies power to the various shafts of the automatic document feeder 400. The automatic document feeder 400 includes a drive roller shaft 302 and a pick arm shaft 404.

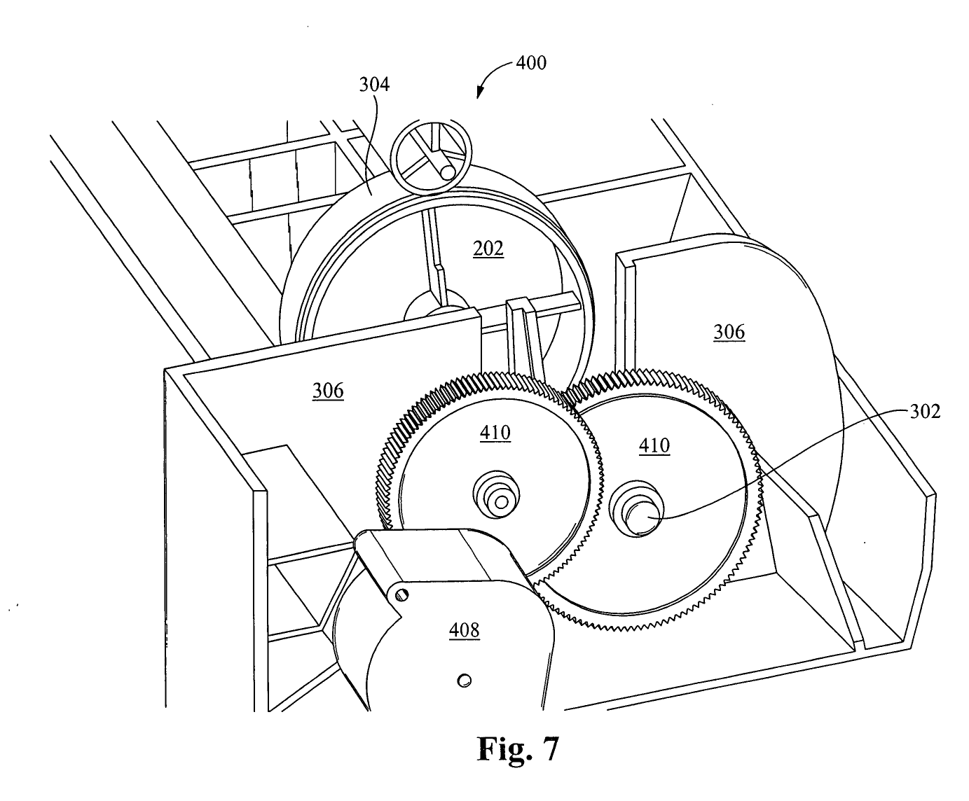

FIG. 7 is a perspective view of the transmission gear train 410 of the automatic document feeder 400, in accordance with the present invention. The chassis 306 holds the components of the automatic document feeder including the transmission gear train 410, the motor 408 and the drive roller shaft 302.

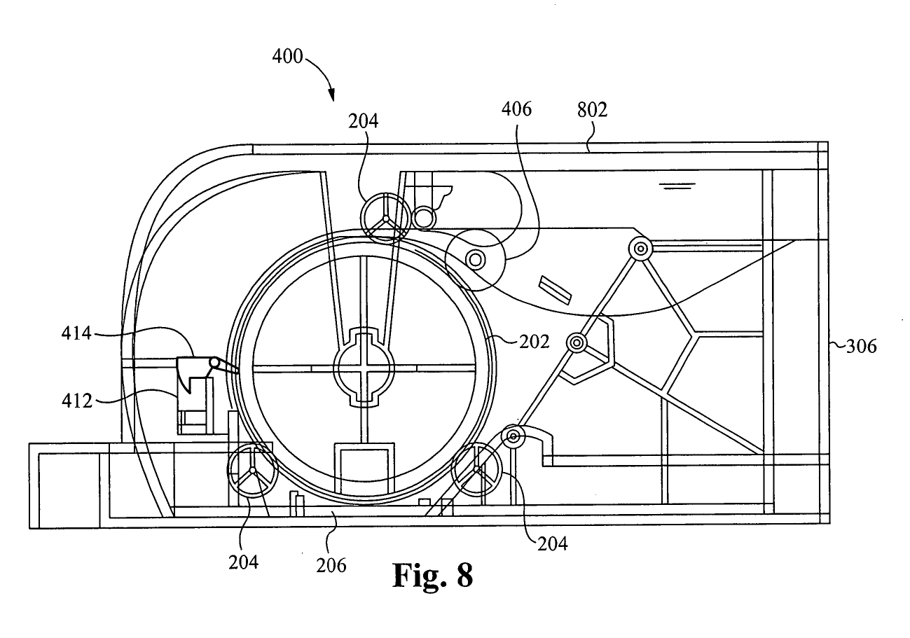

FIG. 8 is a side view of the automatic document feeder 400 of FIG. 4, in accordance with the present invention. A cover top 802 covers internal components, including the drive roller wheel 202, the pinch rollers 204, the float bias 206, the OOPS lever 414, the OOPS 412 and the pick roller wheel 406, among other components. The cover top 802 can include a mechanical safety device (not shown) designed to cease power from the motor to the pick arm, or other components, when the cover top is opened.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. An automatic document feeder comprising a single drive roller including a drive roller wheel, wherein the single drive roller is configured to be an only drive roller in the automatic document feeder.

2. The automatic document feeder of claim 1, wherein the single drive roller further includes a drive roller shaft extending through a center of the drive roller wheel, and wherein the drive roller shaft is fixed to the center of the drive roller wheel, and wherein the drive roller shaft is configured to apply a torque to the drive roller wheel.

3. The automatic document feeder of claim 2, wherein the single drive roller further includes another drive roller wheel, and wherein the drive roller shaft extends through a center of the other drive roller wheel, and wherein the drive roller shaft is fixed to the center of the other drive roller wheel, and wherein the drive roller shaft is configured to apply a torque to the other drive roller wheel.

4. The automatic document feeder of claim 1, wherein a diameter of the drive roller wheel is between about 50 mm and about 53 mm.

5. The automatic document feeder of claim 1, wherein the drive roller wheel has a circumferential surface with traction to grip a media sheet, the automatic document feeder further comprising one or more pinch rollers, wherein the one or more pinch rollers are configured to apply a pinch force onto the circumferential surface, and wherein the pinch force is configured to feed the media sheet through the automatic document feeder.

6. The automatic document feeder of claim 5, wherein the single drive roller is configured to transmit power to the one or more pinch rollers.

7. The automatic document feeder of claim 5, further comprising a scan window, wherein the pinch force is sufficient to feed the media sheet over the scan window.

8. The automatic document feeder of claim 7, wherein the scan window is positioned substantially directly below the drive roller.

9. The automatic document feeder of claim 5, further comprising:
a. a float bias; and
b. a spring biasing the float bias vertically downward, wherein the float bias presses the media sheet downward onto the scan window.

10. The automatic document feeder of claim 5, further comprising an output tray, wherein the single drive roller is further configured to spit the media sheet onto the output tray.

11. The automatic document feeder of claim 5, wherein the drive roller is configured to move the media sheet through the automatic document feeder at a substantially constant speed.

12. The automatic document feeder of claim 2, further comprising:
a. a motor; and
b. a transmission gear train coupled to the motor and the drive roller shaft, wherein the transmission gear train is configured to transmit power from the motor to the drive roller shaft.

13. The automatic document feeder of claim 1, further comprising:
a. an out of paper sensor; and
b. an out of paper lever configured to provide notification when the out of paper sensor senses when the automatic document feeder is out of paper.

14. The automatic document feeder of claim 5, further comprising a chassis configured to hold the single drive roller and the one or more pinch rollers, wherein the chassis operates as a paper guide for the media sheet.

15. The automatic document feeder of claim 5, further comprising:
a. a motor;
b. a pick arm; and
c. a pick arm shaft coupled to the pick arm and the motor, wherein the pick arm is configured to pick and separate the media sheet from a stack of media sheets.

16. The automatic document feeder of claim 15, further comprising a cover top having a mechanical safety device configured to cease power from the motor to the pick arm shaft when the cover top is opened.

17. A single drive roller for use in an automatic document feeder, the single drive roller comprising a drive roller wheel, wherein the single drive roller is configured to be an only drive roller in the automatic document feeder.

18. The single drive roller of claim 17, wherein the drive roller wheel includes a circumferential surface having traction to grip a media sheet onto the circumferential surface, the single drive roller further comprising a drive roller shaft extending through a center of the drive roller wheel, wherein the drive roller shaft is fixed to the center of the drive roller wheel.

19. The single drive roller of claim 18, further comprising another drive roller wheel, wherein the other drive roller wheel includes a circumferential surface having traction to grip the media sheet onto the circumferential surface, and wherein the drive roller shaft extends through a center of the other drive roller wheel, and wherein the drive roller shaft is fixed to the center of the other drive roller wheel.

20. The single drive roller of claim 17, wherein a diameter of the drive roller wheel is between about 50 mm and about 53 mm.

21. The single drive roller of claim 18, wherein the drive roller is configured to move the media sheet through the automatic document feeder at a substantially constant speed.
